(19) United States
(12) Patent Application Publication
(10) Pub. No.: US 2018/0253710 A1
(43) Pub. Date: Sep. 6, 2018

(54) POINT-OF-SALE TERMINAL

(71) Applicant: TOSHIBA TEC KABUSHIKI KAISHA, Tokyo (JP)

(72) Inventors: Tsuyoshi GOTANDA, Ota Tokyo (JP); Takashi NAKAJIMA, Ota Tokyo (JP); Nobuhiro SUGITA, Mishima Shizuoka (JP); Chikashi GOTOU, Yokohama Kanagawa (JP); Jun KIKUCHI, Tagata Shizuoka (JP); Jun MIYAZAKI, Ota Tokyo (JP); Kenya HIRAMATSU, Kita Tokyo (JP)

(21) Appl. No.: 15/889,359

(22) Filed: Feb. 6, 2018

(30) Foreign Application Priority Data
Mar. 3, 2017 (JP) 2017-040933

(51) Int. Cl. G06Q 20/20; G07G 1/12

(52) U.S. Cl. CPC G06Q 20/203; G07G 1/12

(57) ABSTRACT

A point-of-sale (POS) terminal includes a change machine, a receipt printer, a display device, and a processor configured to receive from the change machine, first inventory data relating to stored banknotes and coins in the change machine, and receive from the printer, second inventory data indicating a remaining amount of stored receipt sheet in the printer, and control the display device to display on one screen, an inventory image including a first image representative of the first inventory data and a second image representative of the second inventory data.

### CROSS-REFERENCE TO RELATED APPLICATION

This application is based upon and claims the benefit of priority from Japanese Patent Application No. 2017-040933, filed Mar. 3, 2017, the entire contents of which are incorporated herein by reference.

### FIELD

Exemplary embodiments described herein relate generally to a point-of-sale terminal.

### BACKGROUND

In a checkout system used in a supermarket or the like, a point-of-sale (POS) terminal is widely used to register a commodity that is an object of purchase and to carry out a settlement process for the registered commodity.

In the settlement process, the customer pays for the registered commodity and change is returned as necessary. The POS terminal is provided with an automatic change machine for efficiently handling deposit of cash payment and dispensing change. In the automatic change machine, banknote and coins are stored in advance as change funds, and the deposited money is sorted and stored. The automatic change machine has a function of detecting an inventory of the stored banknote and coins, displaying a near-empty status when the remaining amount of any of the stored banknotes or coins is less than a set value, and notifying an operator of the near-empty status.

In the settlement process, a transaction content is printed and issued as a receipt. In a receipt printer, a receipt sheet is a wound in a roll, and is stored in the printer. The receipt sheet of a necessary amount is drawn out for printing the transaction content thereon and discharged as the receipt. The printer has a light emitting diode (LED) or the like, which starts to blink, when a remaining amount of the receipt sheet wound in the roll is less than a set value (i.e., near-empty), and is capable of notifying the operator thereof.

In recent years, a semi-self-service type checkout system, which is provided with a registration apparatus which mainly executes a registration process and a settlement apparatus which executes a settlement process by an operation of a customer based on transaction information generated by the registration process of the registration apparatus, is used. The automatic change machine and the printer are also provided in the settlement apparatus and similarly, a function of notifying the operator of the near-empty status is provided.

In the POS terminal of the related art, a near-empty state which requires replenishment sometimes occurs while a checkout operation is carried out. In such cases, each of the automatic change machine and the printer individually detects the near-empty status and notifies the operator of the same. Therefore, the operator has to replenish each of banknote and coins, and the roll paper in response to individual notifications thereof.

### DESCRIPTION OF THE DRAWINGS

FIG. 1 is a perspective view illustrating an appearance of a commodity sales data processing apparatus of an embodiment.

FIG. 2 is a view illustrating an example of a combination keyboard of the embodiment.

FIG. 3 is a block diagram illustrating a configuration of the commodity sales data processing apparatus in the embodiment.

FIG. 4 is a view illustrating an example of a remaining amount screen in the embodiment.

FIG. 5 is a flow chart illustrating a management process by a management method in the embodiment.

FIG. 6 is a block diagram illustrating an example of a semi-self-service type check-out system in the embodiment.

### DETAILED DESCRIPTION

Embodiments provide a POS terminal capable of efficiently executing a replenishment operation for a change machine and a printer.

In general, according to an embodiment, a POS terminal includes a change machine, a receipt printer, a display device, and a processor configured to receive from the change machine, first inventory data relating to stored banknotes and coins in the change machine, and receive from the printer, second inventory data indicating a remaining amount of stored receipt sheet in the printer, and control the display device to display on one screen, an inventory image including a first image representative of the first inventory data and a second image representative of the second inventory data.

Hereinafter, an embodiment will be described with reference to the drawings.

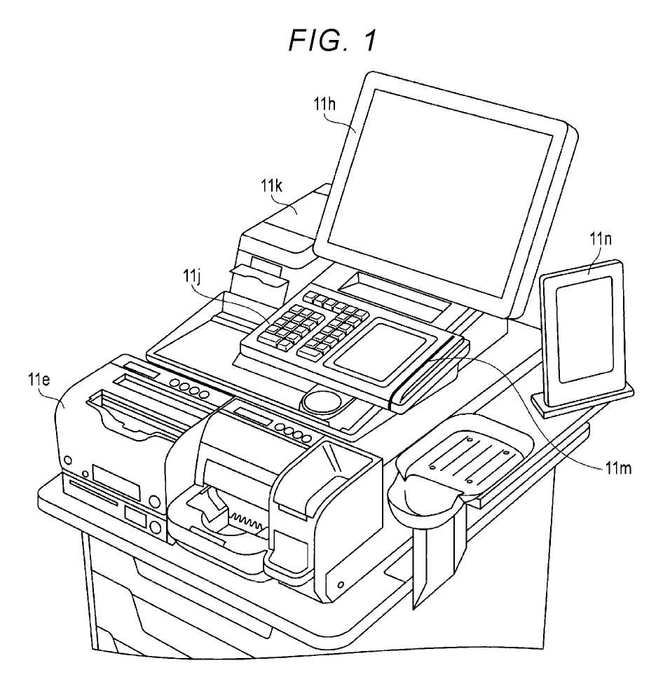

FIG. 1 is a perspective view illustrating an appearance of a POS terminal, depicted as a commodity sales data processing apparatus 10, of an embodiment. The commodity sales data processing apparatus 10 is a part of a checkout system used in a shop such as a supermarket.

As illustrated in FIG. 1, the commodity sales data processing apparatus 10 is provided with a change machine 11e, a touch panel 11h, a combination keyboard 11j (keyboard 11ja and touch panel 11jb), a printer 11k, a card reader and writer 11m, and a display 11n.

In the commodity sales data processing apparatus 10, the touch panel 11h, the combination keyboard 11j, the printer 11k, and the display 11n are detachably mounted on a housing. However, the commodity sales data processing apparatus 10 may be configured to include less than all of the touch panel 11h, the combination keyboard 11j, the printer 11k, and the display 11n, according to its usage at the shop.

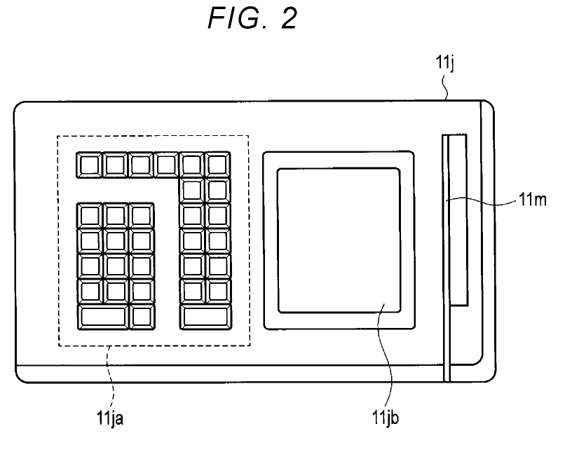

For example, as illustrated in FIGS. 1 and 2, the combination keyboard 11j has the keyboard 11ⱼₐ and the touch panel 11jb. In a modified example, there may be only a keyboard. In the modified example, the space for the touch panel 11jb may be allocated with extra keys of the keyboard. In another modification, the touch panel 11h but not the combination keyboard 11j may be used as an input device. In the embodiment, the combination keyboard 11j is provided with the keyboard 11ja and the touch panel 11jb as illustrated in FIG. 2.

Similarly, the display 11n may be used to show information to the customer. Depending on the circumstance, the display 11n may include a plurality of display units having different screen sizes. A touch panel may be mounted instead of the display 11n so as to receive an input operation by the customer.

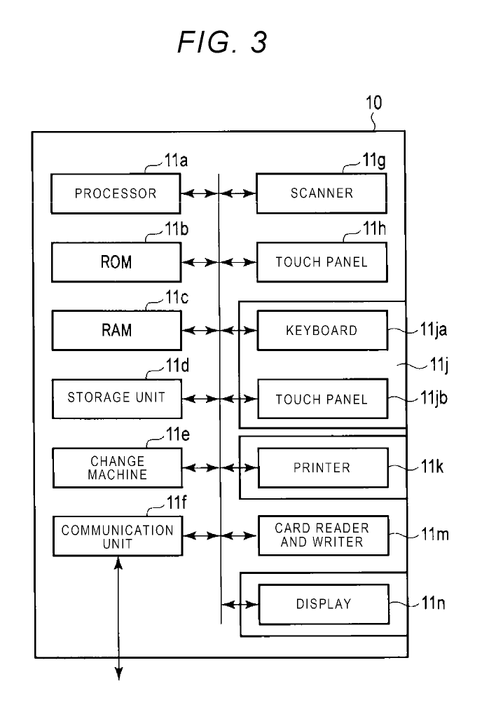

FIG. 3 is a block diagram illustrating a configuration of the commodity sales data processing apparatus 10 of the embodiment.

The commodity sales data processing apparatus 10 includes a processor (e.g., central processing unit (CPU)) 11a, a read-only memory (ROM) 11b, a random-access memory (RAM) 11c, a storage unit 11d, the change machine 11e, a communication unit 11f, a scanner 11g, the touch panel 11h, the combination keyboard 11j (keyboard 11ja and touch panel 11jb), the printer 11k, the card reader and writer 11m, and the display 11n.

The processor 11a is a circuit for controlling each unit of the commodity sales data processing apparatus 10 based on an operating system, middleware, and an application program stored in the ROM 11b and the RAM 11c.

The ROM 11b and the RAM 11c record various programs executed by the processor 11a as well ascertain data when the processor 11a performs various processes. For example, in the RAM 11c, a registered commodity table is recorded when a registration process is executed. In the table, commodity information is registered. In the RAM 11c, data indicating a remaining amount of coins (including coin package (coin-roll)) and a remaining amount of banknote, stored in the change machine 11e, and data indicating a remaining amount of receipt sheets are recorded.

The program executed by the processor 11a includes a control program for executing a process of inputting information of a commodity through the scanner 11g, a process of generating transaction information used for a settlement process according to information of a commodity registered in the registered commodity table, a settlement process based on the transaction information, or the like. The program executed by the processor 11a further includes a management program for displaying a screen indicating coins and banknote stored in the change machine 11e, and the remaining amount of the receipt sheet stored in the printer 11k based on inventory data received from the change machine 11e and the remaining amount data received from the change machine 11e.

The processor 11a executes functions of a first receiving unit configured to receive the inventory data from the change machine 11e based on the management method, a second receiving unit configured to receive the remaining amount data from the printer 11k, and a display unit configured to display a inventory image indicating the inventory of banknote and coins according to the inventory data and a sheet remaining amount image indicating the remaining amount of the receipt sheet according to the remaining amount data, on one screen.

The storage unit 11d stores data used by the processor 11a for performing various processes, or data generated by a process of the processor 11a. An example of the storage unit 11d may be an electric erasable programmable read only memory (EEPROM), a hard disk drive (HDD), a solid state drive (SSD).

The change machine 11e is a device that automatically performs deposit and payment of cash in conjunction with the settlement process by the processor 11a, receives (deposits) coins and banknotes input by the operator, and pays (dispenses) coins and banknote as change. The change machine 11e is provided with a coin-roll storage device that receives a coin package (hereinafter, referred to as the coin-roll) in which several dozen coins (for example, 50 coins) are wound like a roll shape by cellophane. The coin-roll storage device can receive a plurality of the coin-rolls for each coin denomination.

The change machine 11e has a function of detecting an inventory of the stored banknote and coins and an inventory of the coin-roll stored in the coin-roll storage device. The change machine 11e may be provided with a banknote storage unit and a coin storage unit. The banknote storage unit includes a banknote storage box for each banknote denomination. The change machine 11e detects the banknote stored or discharged in or from each of the banknote storage boxes by a storage sensor and counts the number of the banknotes respectively stored in the banknote storage box for each banknote denomination. When the banknote inserted into a deposit port is detected by a deposit sensor, the change machine 11e identifies the banknote denomination, and whether it is counterfeit or not. Then, the change machine 11e sorts the deposited banknotes by their denominations according to the identification result, and stores them in their corresponding banknote storage box. The change machine 11e dispenses as change a number of banknotes for each of the banknote denominations from the corresponding banknote storage box through the payment port according to a payment instruction from the processor 11a.

The coin storage unit includes a coin storage box for each coin denomination. The change machine 11e detects the coin stored in each coin storage box by a storage sensor and counts the number of coins stored in the coin storage box of each coin denomination. When a coin inserted into a deposit port is detected by a deposit sensor, the change machine 11e identifies the coin denomination and whether it is counterfeit or not. Then, the change machine 11e sorts the deposited coins by their denominations according to the identification result, and stores them in their corresponding coin storage box. The change machine 11e dispenses as change a number of coins for each of the coin denominations from the corresponding coin storage box through the payment port according to a payment instruction from the processor 11a.

The coin-roll storage device includes a drawer capable of storing banknotes and the coin-rolls of different coin denominations in order to replenish the banknotes and coins. The drawer can be drawn out from a front side and has the coin-roll storage unit and the banknote storage unit. The coin-roll storage unit is provided with a plurality of the coin-roll holders for storing the plurality of the coin-rolls one by one. Each coin-roll holder is provided with a coin-roll sensor that detects the number of the coin-rolls stored therein.

The change machine 11e can transmit the inventory data indicating the number of the banknotes and the coins respectively stored in the banknote storage unit and the coin storage unit, and the number of the coin-rolls detected by the coin-roll sensor of the coin-roll storage device, which are counted according to the detection by the storage sensor, to the processor 11a at a predetermined transmission timing.

The communication unit 11f communicates with a server or another commodity sales data processing apparatus via a LAN 14.

The scanner 11g reads commodity information by optical scanning and inputs a commodity code uniquely given to each commodity. The scanner 11g may be a fixed type or a handy two-dimensional code scanner or may be a type that identifies the commodity by using an image recognition technique from an image obtained by imaging the commodity. For the scanner 11g, only one type may be provided or a plurality of types may be provided.

The touch panel 11h is a device on which an input operation is performed by the operator (store clerk) and includes a display device and a touch sensor. The display device displays any screen such as a Graphical User Interface (GUI) screen. For example, the display device displays a registration screen including a list of the transaction information (e.g., commodity name, amount of money, or the like) relating to the registered commodity, a subtotal amount various menus, and a button for inputting a command. An example of the display device is a color Liquid Crystal Display (LCD). The touch sensor is disposed to overlap a display surface of the display device. The touch sensor detects a touch position of the operator on the display surface of the display device and sends position information to the processor 11a.

The combination keyboard 11j is a device on which an input operation is performed by the operator (store clerk) and includes, for example, the keyboard 11ja and the touch panel 11jb in which a plurality of keys to which specific functions are assigned individually are arranged. For example, similar to the touch panel 11h, the touch panel 11jb includes a display device and a touch sensor. The touch panel 11jb displays supplementary information that does not need to be displayed at all times, information (e.g., special sale information, a message from a store manager, or the like) to be shared by the operators within the store. In the touch panel 11jb, the inventory image indicating the remaining inventory of banknote and coins stored in the change machine 11e, and the sheet remaining amount image indicating the remaining amount of the receipt sheet stored in the printer 11k, are displayed on one screen.

The printer 11k may be a thermal printer, a dot impact printer. The printer 11k issues a transaction receipt, an issue receipt, a coupon ticket, or the like, on which the transaction content such as a commodity name, a unit price, or a total price is printed by printing various character strings, images, code patterns (e.g., barcodes, two-dimensional codes, and the like) on the receipt sheet. In the printer 11k, for example, the receipt sheet which is wound in a roll is stored, and an amount necessary for printing the transaction content thereon is drawn out for each transaction and is cut to be discharged. The printer 11k is provided with a function of detecting the remaining amount of the sheet wound on the receipt sheet. For example, the printer 11k is provided with a remaining amount sensor that detects that the receipt sheet reaches a predetermined remaining amount (near-empty state) and can transmit remaining amount data indicating the remaining amount detected by the remaining amount sensor to the processor 11a. The printer 11k may be provided with a remaining amount sensor which detects not only the near-empty state (state of which a value is smaller than a predetermined set value) but also detects the remaining amount in a plurality of stages or continuously. In this case, the printer 11k can transmit the remaining amount data indicating the remaining amount of the receipt sheet wound in a roll to the processor 11a.

The card reader and writer 11m reads data recorded on a card and writes data to the card. The card includes various cards for recording information relating to the settlement process, such as a membership card and a point card in addition to a settlement card such as a credit card, a debit card, an electronic money card, or a prepaid card. The card reader and writer 11m may be a magnetic type, a contact type, and a non-contact type, and may include a plurality of types of devices.

The display 11n is for providing information to the customer and a color LCD may be used.

Next, an operation of the commodity sales data processing apparatus 10 in the embodiment will be described.

When the commodity sales data processing apparatus 10 is activated in a mode for performing a registration process of the commodity, a control process is started by the processor 11a based on a control program stored in the ROM 11b or the storage unit 11d.

When the control process is started, the processor 11a clears the registered commodity table stored in the RAM 11c and displays a registration screen on the touch panel 11h. The registration screen is provided to display information of the commodity registered in the registered commodity table or the like and is a screen for allowing the operator to confirm an execution status of the registration process.

When the commodity code attached to the commodity is read and detected using the scanner 11g by an operation of the operator, the processor 11a registers the information of the commodity corresponding to the commodity code in the registered commodity table. The processor 11a updates the commodity information in the registration screen according to the updated registered commodity table. Thereafter, as described above, the processor 11a sequentially adds the commodity information to the registered commodity table as different commodity codes are read and detected by the scanner 11g.

After at least one commodity is registered, when it is detected that the subtotal button is operated, the processor 11a generates the transaction information for the settlement process relating to the commodity registered in the registered commodity table. The processor 11a causes a subtotal screen including information such as the list of the registered commodity and the total number and the total price of the registered commodities, to be displayed on the touch panel 11h. When it is detected that an accounting button provided in the subtotal screen is operated, the processor 11a performs a closing process for completing the registration process and then executes the settlement process based on the transaction information.

In the settlement process, when banknote and coins deposited from the customer as payment for the purchased commodity are input to the change machine 11e and change is required to be paid out, the change is discharged from the change machine 11e. The transaction receipt on which the transaction content is printed is issued from the printer 11k.

In the commodity sales data processing apparatus 10, the settlement process for the transaction with the customer is executed and thereby the remaining amount of banknote and coins stored in the change machine 11e fluctuates. The remaining amount of the receipt sheet stored in the printer 11k decreases as the receipt or the like is issued. The processor 11a executes a management process based on the management method and displays an inventory image indicating the remaining inventory of banknote and coins and a sheet remaining amount image indicating the remaining amount of the receipt sheet on one screen according to the inventory data received from the change machine 11e and the remaining amount data received from the printer 11k.

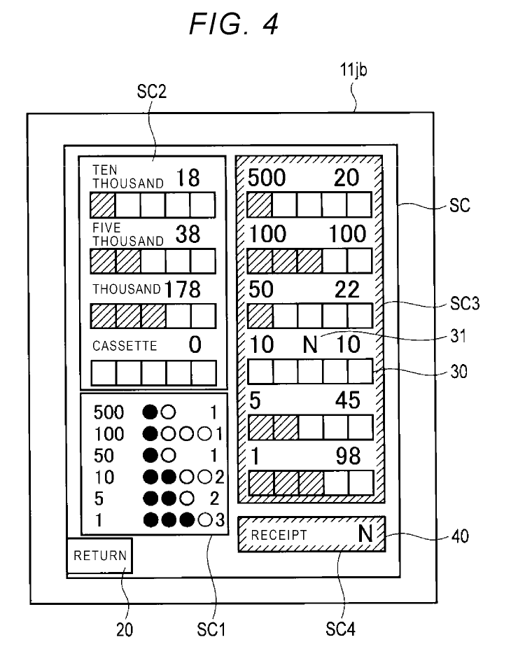

FIG. 4 is a view illustrating an example of a remaining amount screen SC in the embodiment. In the commodity sales data processing apparatus 10 in the embodiment, the remaining amount screen SC is displayed on the touch panel 11jb. Since the touch panel 11jb is provided independently of the touch panel 11h, the registration screen is not hidden by displaying the remaining amount screen SC so that it does not hinder the recognition processing. The remaining amount screen SC can be displayed at any timing irrespective of the recognition processing. For example, the remaining amount screen SC can be automatically displayed in response to an input operation from the operator or in the event of a specific condition irrespective of the input operation from the operator. When the remaining amount screen SC is displayed on the touch panel 11jb, the remaining amount screen SC is displayed only for a predetermined time and then may be returned to an original display screen, or may be displayed until the operator instructs (for example, an input operation with respect to a return button) the display to end.

An example of the condition for automatic display is when a specific change occurs in the inventory of the change machine 11e or when the remaining amount of the receipt sheet in the printer 11k is changed to a specific amount. In this case, the processor 11a causes the touch panel 11jb to display the remaining amount screen SC without input operation from the operator. For example, when the state is near-empty and a warning display is required to the operator, the remaining amount screen SC is automatically displayed. When the remaining amount screen SC is not displayed on the touch panel 11jb, the space may be utilized differently. For example, the touch panel 11jb may display supplementary information that does not need to be displayed at all times. Alternately, the touch panel 11jb may display information to be shared by the operators in the store.

The example of the remaining amount screen SC illustrated in FIG. 4, is a coin-roll inventory image SC1 indicating the inventory of the coin-roll of each coin denomination (e.g., 500, 100, 50, 5, and 1) stored in the change machine 11e, a banknote inventory image SC2 indicating the inventory of the banknote of each banknote denomination (e.g., ten thousand, five thousand, and thousand) stored in the change machine 11e, a coin inventory image SC3 indicating the inventory of the coin of each coin denomination (e.g., 500, 100, 50, 5, and 1) stored in the change machine 11e, a sheet remaining amount image SC4 indicating the remaining amount of the receipt sheet stored in the printer 11k, and a button 20 for inputting an instruction to return the display of the touch panel 11jb to the original display.

In the coin-roll inventory image SC1, the number of the remaining stored coin-rolls and the number of the used coin-rolls are displayed by white circle and black circle. In the banknote inventory image SC2 and the money inventory image SC3, a ratio of the remaining inventory and the used money is displayed by graphs, and numbers indicating the remaining inventory are displayed. For the denomination in the near-empty state (10-yen coin in FIG. 4), a graph 30 is displayed so as to indicate that there is no inventory and a character “N” 31 indicating near-empty, is added. Since there is a denomination in the near-empty state, the coin inventory image SC3 is changed to a display form that is different from normal, for example, of which a background color is changed to a conspicuous color so that the operator can reliably recognize that a warning is displayed. Also for the remaining amount screen SC, when there is a denomination which is in the near-empty state, the display form is changed so as to be different from normal. In the sheet remaining amount image SC4, at least one of a figure and a character indicating the remaining amount of the receipt sheet stored in the printer 11k is displayed. In the sheet remaining amount image SC4, only when the receipt sheet stored in the printer 11k is in the near-empty state, it is displayed as illustrated in FIG. 4. In FIG. 4, a character “N” 40 indicating that there is the near-empty state is added and the display form is changed (e.g., background color is changed, or the like) so as to be different from normal. As an example of changing the display form in order to clearly indicate that warning is displayed, the background color is changed, but other display forms such as a blinking display and a moving image such as animation can be used in addition to changing a display color or a line type of the figure and the character.

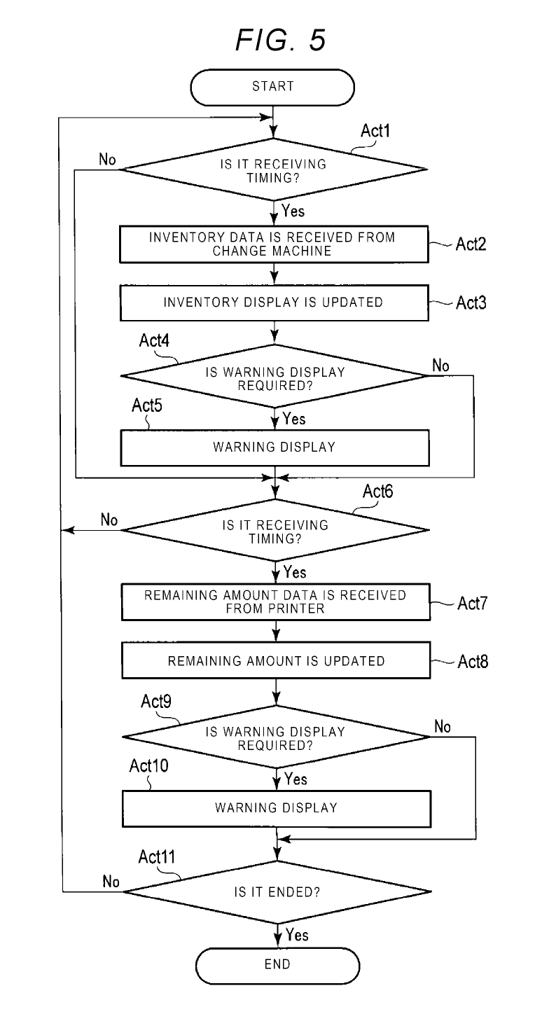

Hereinafter, a process will be described where a warning display is required on the remaining amount screen SC. FIG. 5 is a flow chart illustrating the management process by the management method in the embodiment.

The processor 11a receives the inventory data from the change machine 11e when it is timing to receive the inventory data from the change machine 11e (Yes in Act 1). The inventory data includes data indicating the remaining inventories of the banknote, the coins, and the coin-roll of the plurality of the denominations stored in the change machine 11e. As the reception timing, for example, the processor 11a may issue a transmission request of the inventory data with respect to the change machine 11e, for example, at predetermined time intervals or the change machine 11e may transmit the inventory data at predetermined time intervals. When a preset amount of change in the inventory (the banknote, money, and the coin-roll) in the change machine 11e has been reached, the inventory data can be transmitted from the change machine 11e. For example, when a change in the inventory causes a change in the display of the graphic indicating the inventory in the remaining amount screen SC, or when a denomination is determined to be near-empty (equal to a reference value or less), the change machine 11e transmits the inventory data to the processor 11a.

When the processor 11a receives the inventory data from the change machine 11e (Act 2), the remaining amount screen SC is displayed on the touch panel 11jb and the display content of the banknote inventory image SC2 or the coin inventory image SC3 is updated according to the inventory data (Act 3).

Here, when it is determined whether or not the warning display is required based on the inventory data (near-empty, no remaining amount), the processor 11a changes the banknote inventory image SC2 or the coin inventory image SC3 to the display form indicating the warning. For example, as illustrated in FIG. 4, when 10-yen coin is in the near-empty state, the graphic 30 is displayed so as to indicate there is no inventory, and the character “N” 31 indicating near-empty is added and the background color of the coin inventory image SC3 is changed to a color indicating the warning.

On the other hand, when it is time to receive the remaining amount data from the printer 11k (Yes in Act 6), the processor 11a receives the remaining amount data from the printer 11k. The remaining amount data includes data indicating the remaining amount of the receipt sheet stored in the printer 11k. As the reception timing, for example, it is possible to issue a transmission request of the remaining amount data with respect to the printer 11k at predetermined time intervals from the processor 11a, or the printer 11k may transmit the remaining amount data at predetermined time intervals. When the remaining amount of the receipt sheet in the printer 11k has reached a preset amount, the remaining amount data can be transmitted from the printer 11k.

For example, when a change in the remaining amount of the receipt sheet causes a change in the display of the graphic indicating the remaining amount of the receipt sheet in the remaining amount screen SC, the printer 11k transmits the remaining amount data to the processor 11a. If notification (warning) is required to be given to the operator only when the receipt sheet of the printer 11k is in the near-empty state (remaining amount is equal to a preset value or less), the remaining amount data may be received at the timing when the receipt sheet is in the near-empty state in the printer 11k.

When the processor 11a receives the remaining amount data from the printer 11k (Act 7), the remaining amount screen SC is displayed on the touch panel 11jb and the display content of the sheet remaining amount image SC4 is updated according to the remaining amount data (Act 8).

Here, when it is determined whether or not the warning display is required based on the remaining amount data (near-empty, no remaining amount), the processor 11a changes the sheet remaining amount image SC4 to the display form indicating the warning. For example, as illustrated in FIG. 4, in the near-empty state, the character “N” 40 is added to the sheet remaining amount image SC4 to indicate the near-empty state and the background color of the sheet remaining amount image SC4 is changed to a color indicating the warning.

The timing of receiving the inventory data from the change machine 11e (Act 1) and the timing of receiving the remaining amount data from the printer 11k (Act 6) may be the same, or different timings.

In the above description, the remaining amount screen SC is displayed in the touch panel 11jb, but may be displayed in the touch panel 11h. For example, when nothing is displayed on the touch panel 11h, such as when the registration process is not performed, the remaining amount screen SC maybe displayed on the touch panel 11h according to the instruction by the input operation of the operator.

In this manner, in the commodity sales data processing apparatus 10 in the embodiment, the inventory image (e.g., the coin-roll inventory image SC1, the banknote inventory image SC2, and the coin inventory image SC3) indicating the inventory of banknote and coins stored in the change machine 11e, and the sheet remaining amount image (sheet remaining amount image SC4) indicating the remaining amount of the receipt sheet stored in the printer 11k can be displayed on, for example, one screen of the touch panel 11jb. Therefore, the operator can simultaneously grasp the status of the change machine 11e and the printer 11k from the remaining amount screen SC. Therefore, in each of the change machine 11e and the printer 11k, it is unnecessary to individually deal with the status requiring the replenishment operation which is individually generated, and it is possible to efficiently execute the replenishment operation for the change machine 11e and the printer 11k. For example, when the fact that the remaining of the receipt sheet of the printer 11k is reduced (near-empty state) is displayed on the sheet remaining amount image SC4, it is possible to recognize that the remaining inventory of banknotes and coins has been reduced to an extent that it is better to replenish the change machine 11e. In this case, it is possible to perform the replenishment of the banknote and coins along with replacement of the receipt sheet at an idle time when the customer is interrupted. Therefore, it is possible to improve the efficiency of the replenishment operation with respect to the commodity sales data processing apparatus 10.

In the above description, a case where the inventory and the remaining amount of the change machine 11e and the printer 11k connected to one commodity sales data processing apparatus 10 are displayed is described, but it is possible to realize in a semi-self-service type check-out system provided with a registration apparatus and a settlement apparatus.

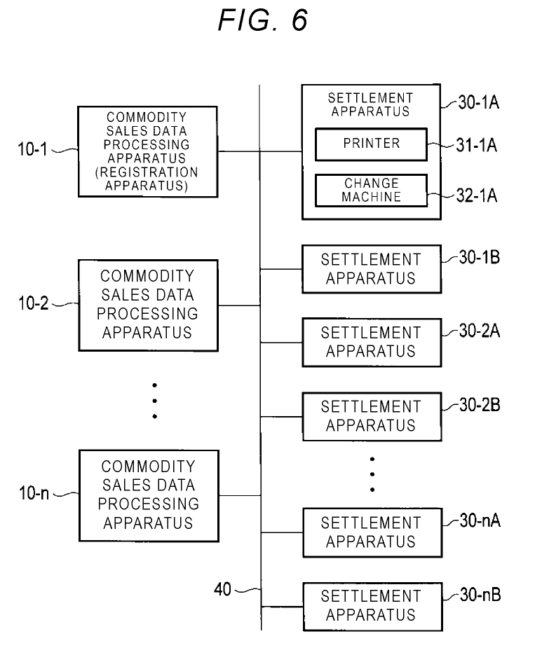

FIG. 6 is a block diagram illustrating an example of the semi-self-service type check-out system.

In FIG. 6, commodity sales data processing apparatuses 10-1, 10-2, . . . , 10-n are configured similar to the commodity sales data processing apparatus 10 described above, and are used as the registration apparatus generating the transaction information for the settlement process for the commodity. Settlement apparatuses 30-1A and 30-1B execute the settlement process based on the transaction information generated by the commodity sales data processing apparatus 10-1. Similarly, settlement apparatuses 30-2A and 30-2B and settlement apparatuses 30-nA and 30-nB respectively execute the settlement process based on the transaction information generated by the commodity sales data processing apparatuses 10-2 and 10-n. Each apparatus is connected to a network such as a Local Area Network (LAN) and can transmit and receive data.

In each of the settlement apparatuses 30-1A to 30-nB, devices (the touch panel, the printer 31-1A, the change machine 32-1A) which are used in the settlement process are provided similar to the commodity sales data processing apparatus 10 in order to execute the settlement process according to the operation of the customer. Similar to the change machine 11e described above, the change machine 32-1A has a detection function of detecting the inventory of the stored banknote and coins, and transmits the inventory data indicating the inventory of the banknote and coins to the commodity sales data processing apparatus 10-1. Similar to the printer 11k described above, the printer 31-1A has a detection function of detecting the remaining amount of the stored receipt sheet and transmits the remaining amount data indicating the remaining amount of the receipt sheet to the commodity sales data processing apparatus 10-1.

The commodity sales data processing apparatus 10-1 receives the inventory data indicating the inventory of the change machine 32-1A from each of the settlement apparatuses 30-1A and 30-1B located under the commodity sales data processing apparatus 10-1. Then, The commodity sales data processing apparatus 10-1 receives the remaining amount data of the receipt of the printer 31-1A, and causes the touch panel 11jb to display the remaining amount screen SC based on the data. On the remaining amount screen SC, the remaining amount screen SC may be displayed corresponding to the two settlement apparatuses 30-1A and 30-1B on one screen, or may be displayed one of them and refer to the other by switching one remaining amount screen SC.

The commodity sales data processing apparatus 10-1 not only displays the remaining amount screen SC for the settlement apparatuses 30-1A and 30-1B located under the commodity sales data processing apparatus 10-1, but also receives the inventory data and the remaining amount data from each of the settlement apparatuses 30-2A, 30-2B, . . . , 30-nA, and 30-nB, and can display the remaining amount screen SC corresponding to each settlement apparatus. Similarly, the commodity sales data processing apparatus 10-1 receives the inventory data and the remaining amount data from each of the commodity sales data processing apparatuses 10-2, and 10-n, and can display the corresponding remaining amount screen SC. Therefore, it is possible to manage the inventory and the remaining amount not only for the settlement apparatuses 30-1A and 30-1B, but also for the settlement apparatuses 30-2A, 30-2B, . . . , 30-nA, and 30-nB, and the commodity sales data processing apparatuses 10-2, and 10-n by the operator operating the commodity sales data processing apparatus 10-1.

In the semi-self-service type checkout system, similarly, the inventory data and the remaining amount data are received from a plurality of self-service registration apparatuses and the remaining amount screen SC corresponding to each self-service registration apparatus can be displayed.

In this manner, also in the semi-self-service type or self-service type checkout system checkout system, it is possible to confirm the both inventory of the change machine and the remaining amount of the receipt sheet in a plurality of other apparatuses in the remaining amount screen SC. In addition, it is possible to efficiently replenish the change machine and the printer provided in the plurality of the other apparatuses.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein maybe made without departing from the spirit of the inventions. The accompanying claims and their equivalents are intended to cover such forms or modifications as would fall within the scope and spirit of the inventions.

The process described in the above-described embodiment can be provided to various apparatuses by being written on, for example, a recording medium such as a magnetic disk (a flexible disk, a hard disk), an optical disk (a CD-ROM, a DVD), and a semiconductor memory as a program that can be executed by a computer. Further, the process can be transmitted by a communication medium and can be provided to various apparatuses. A computer reads a program recorded on a recording medium or receives a program via a communication medium, and the operation is controlled by the program to execute the above-described process.

What is claimed is:

1. A point-of-sale (POS) terminal comprising:
a change machine;
a receipt printer;
a display device; and
a processor configured to receive from the change machine, first inventory data relating to stored banknotes and coins in the change machine, and receive from the printer, second inventory data indicating a remaining amount of stored receipt sheet in the printer, and control the display device to display on one screen, an inventory image including a first image representative of the first inventory data and a second image representative of the second inventory data.

2. The POS terminal according to claim 1, further comprising:
a display device configured to display information relating to a commodity to be purchased.

3. The POS terminal according to claim 1, wherein
the first inventory data also indicates a remaining amount of coins stored in a coin-roll state.

4. The POS terminal according to claim 3, wherein the second image includes a first portion representing the inventory data relating to the banknotes stored in the change machine, a second portion representing the inventory data relating to the coins stored in the change machine, and a third portion representing the inventory data relating to the coin-rolls stored in the change machine.

5. The POS terminal according to claim 4, wherein the first portion of the second image includes a separate graphic for each of the banknote denominations, and the second and third portions of the second image each include a separate graphic for each of the coin denominations.

6. The POS terminal according to claim 5, wherein the processor, upon detecting a near-empty status for any of the banknote denominations, the coin denominations, and the receipt sheet, controls the display device to display the corresponding portion of the first or second image in a conspicuous manner.

7. The POS terminal according to claim 6, wherein the display of the near-empty status is made conspicuous by causing the corresponding portion of the display to blink.

8. The POS terminal according to claim 6, wherein the display of the near-empty status is made conspicuous by changing a background color of the corresponding portion of the display.

9. The POS terminal according to claim 6, wherein the display of the near-empty status is made conspicuous by displaying a marking next to the corresponding portion of the display.

10. The POS terminal according to claim 1, wherein the receipt sheet is stored in the printer in the form of a roll.

11. A method of operating a point-of-sale (POS) terminal that includes a change machine, a receipt printer, and a display device, said method comprising:
receiving from the change machine, first inventory data relating to stored banknotes and coins in the change machine, and from the printer, second inventory data indicating a remaining amount of stored receipt sheet in the printer; and
displaying on one screen, an inventory image including a first image representative of the first inventory data and a second image representative of the second inventory data.

12. The method according to claim 11, further comprising:
displaying information relating to a commodity to be purchased.

13. The method according to claim 11, wherein
the first inventory data also indicates a remaining amount of coins stored in a coin-roll state.

14. The method according to claim 13, wherein the second image includes a first portion representing the inventory data relating to the banknotes stored in the change machine, a second portion representing the inventory data relating to the coins stored in the change machine, and a third portion representing the inventory data relating to the coin-rolls stored in the change machine.

15. The method according to claim 14, wherein the first portion of the second image includes a separate graphic for each of the banknote denominations, and the second and third portions of the second image each include a separate graphic for each of the coin denominations.

16. The method according to claim 15, further comprising:
upon detecting a near-empty status for any of the banknote denominations, the coin denominations, and the receipt sheet, displaying the corresponding portion of the first or second image in a conspicuous manner.

17. The method according to claim 16, wherein the display of the near-empty status is made conspicuous by causing the corresponding portion of the display to blink.

18. The method according to claim 16, wherein the display of the near-empty status is made conspicuous by changing a background color of the corresponding portion of the display.

19. The method according to claim 16, wherein the display of the near-empty status is made conspicuous by displaying a marking next to the corresponding portion of the display.

20. The method according to claim 11, wherein the receipt sheet is stored in the printer in the form of a roll.
